(19) United States
(12) Patent Application Publication
(10) Pub. No.: US 2025/0272543 A1
(43) Pub. Date: Aug. 28, 2025

(54) Machine Learning Framework for Human Data Detection

(71) Applicant: Capital One Services, LLC, McLean, VA (US)

(72) Inventors: Bozhao Tan, Sunnyvale, CA (US); Mohammadamin Dashti Moghaddam, Pleasant Hill, CA (US); Milad Asgari Mehrabadi, Irvine, CA (US); Maryam Ghaseri, Weehawken, NJ (US); Shiyong Li, San Francisco, CA (US); Kishore Mosaliganti, Lexington, MA (US); Dave Anderson, Chambersburg, PA (US); Brandi Cassell, Washington, DC (US); Robert Hudson, Falls Church, VA (US); Eddy Borera, Chantilly, VA (US); Ashish Prasad Gupta, Richmond, VA (US)

(21) Appl. No.: 18/589,013

(22) Filed: Feb. 27, 2024

(51) Int. Cl. G06N 3/0455

(52) U.S. Cl. CPC G06N 3/0455

(57) ABSTRACT

Methods, systems, and apparatuses are described herein for detecting human data. A machine learning model may be trained to predict, based on an input vector representing a column name, whether the column name corresponds to human data. A computing device may process, using a fuzzy string-matching algorithm, a column name to determine if the column name corresponds to one or more known human data categories. If the fuzzy string-matching algorithm does not find a match, an expanded column name might be generated by mapping the column name to a vector space using a transformer model. That expanded column name may be provided to one or more input nodes of the trained machine learning model and, based on output from the trained machine learning model, the computing device may store metadata, associated with the first column, that indicates whether the first column comprises human data.

### FIELD OF USE

Aspects of the disclosure relate generally to human data detection. More particularly, aspects described herein utilize multiple machine learning techniques to programmatically identify and protect human data.

### BACKGROUND

Human data broadly refers to data relating to individuals, and can include everything from survey responses to social media posts. Generally, such information is worth protecting because it relates to individuals, which might have privacy interests in that data. A subset of human data is Personally Identifiable Information (PII), which presents more risk if inadvertently disclosed because it might identify a particular person. Examples of such PII include names, e-mail addresses, physical addresses, and the like. An even further subset of PII is Highly Sensitive Human Data (HSHD), which includes passport numbers, driver's license numbers, Employer Identification Number (EIN) fields, tax identifiers, and the like. This data is particularly sensitive, and requires enhanced protection.

Enterprises are strongly motivated to both identify and protect human data, PII, and HSHD. Indeed, protecting these forms of data is extremely important, and many enterprises devote significant capital and computational investment to encrypting data, tokenizing data, and the like. That said, the data must first be identified as human data, PII, and/or HSHD to be protected. For example, an enterprise that inadvertently misconfigures its databases might store PII in a manner which is unprotected, making that PII vulnerable to inadvertent disclosure. This is a particular risk for large enterprises which receive vast quantities of data from various sources, as the provider of such data might not properly tag aspects of the data as human data, PII, and/or HSHD. For example, an enterprise that receives petabytes of data per day from various third-party sources might have a hard time knowing which aspects of that data might be personal, PII, and/or HSHD without expending the significant effort to process the data manually.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein relate to human data detection and classification through machine learning techniques, such as deep neural networks. Tabular data might be received, and that tabular data might comprise a variety of column names (e.g., “accountID,” “addr”). These column names might be expanded (e.g., “Account Identifier,” “Address”) and corresponding column descriptions might be retrieved (e.g., “An identifier of the customer's account,” “The physical address of a customer”). Those expanded column names and corresponding column descriptions might be processed to determine embeddings, which might be provided to a machine learning model implemented using a neutral network. That neural network model might process the embeddings to identify a predicted likelihood that a particular column comprises human data, PII, and/or HSHD (collectively referred to herein as human data and/or sensitive data). The result of this processing is a machine-learning-implemented identification of possible inclusion of human data, PII, and/or HSHD in particular tabular data columns without requiring the direct processing of that data (which can be computationally costly and time-consuming) and in a manner which can leverage a variety of different techniques (e.g., fuzzy string matching, character-based convolutional neural networks) to improve the ability of a computing device to quickly and accurately predict the likelihood of human data, PII, and/or HSHD.

More particularly, a computing device may receive a trained machine learning model configured to predict, based on an input vector representing a column name, whether the column name corresponds to human data. That trained machine learning model may have been generated by training a machine learning model using training data comprising a plurality of vectors tagged based on whether each of the plurality of vectors correspond to human data. The computing device may receive tabular data comprising a plurality of columns of data, then identify a first column name of a first column of the plurality of columns of the data. The computing device may then process, using a fuzzy string-matching algorithm, the first column name to determine if the first column name corresponds to one or more known human data categories. Based on determining that the fuzzy string-matching algorithm did not find a match between the first column name and the one or more known human data categories, the computing device may perform a number of steps. The computing device may determine, based on the first column name, a column description corresponding to the first column. The computing device may then generate an expanded column name corresponding to the first column by providing, to a transformer model, the column name, and receiving, from the transformer model, a mapping of the column name to a vector space. The computing device may also generate an expanded column description corresponding to the first column by processing the column description. The computing device may provide the expanded column name and an expanded column description to one or more input nodes of the trained machine learning model and then receive, as output from one or more output nodes of the trained machine learning model, an indication of whether the first column comprises human data. The computing device may then store metadata, associated with the first column, that indicates whether the first column comprises human data. The indication of whether the first column comprises human data may comprise an indication of whether the first column comprises, for example, PII, HSHD, or the like.

The transformer model used to map the column name to the vector space may be a variety of different transformer model. For example, the transformer model may comprise a character-level transformer model, and the mapping of the column name to the vector space may comprise a character-by-character mapping of the column name to the vector space. Additionally and/or alternatively, the transformer model may comprise a sentence-level transformer model, and the mapping of the column name to the vector space may comprise a word-by-word mapping of the column name to the vector space. Moreover, the transformer model may be pretrained. For example, the computing device may pretrain the transformer model based on a training set comprising a plurality of different sentence pairs.

As suggested by the description above, some steps may be taken based on determining that a fuzzy string-matching algorithm did not find a match between the first column name and the one or more known human data categories. As part of this process, the computing device may calculate a Levenshtein distance between the first column name and a name of each of the one or more known human data categories. In this manner, the determining that a fuzzy string-matching algorithm did not find a match between the first column name and the one or more known human data categories may be based on, for example, the Levenshtein distance not satisfying a threshold.

The trained machine learning model may be further trained (e.g., improved, retrained through a feedback loop) in a variety of ways. For example, the computing device may process at least a portion of the tabular data corresponding to the first column to identify one or more human data elements, determine, based on the one or more human data elements, that the first column stores human data, and further train the trained machine learning model based on the determination that the first column stores human data. Additionally and/or alternatively, the computing device may receive, via a user interface, user input indicating that the first column stores human data and then further train the trained machine learning model based on the user input indicating that the first column stores human data.

Corresponding methods, apparatus, systems, and non-transitory computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example deep neural network architecture for a model according to one or more aspects of the disclosure;

FIG. 3 depicts a method comprising steps for identifying human data which may be performed by a computing device, such as any one of the devices described with respect to FIG. 1 and/or FIG. 2.

FIG. 4 depicts a simplified decision flow for determining whether a column comprises human data.

FIG. 5A depicts illustrative performance based on a MiniLM model without training.

FIG. 5B depicts illustrative performance based on a MiniLM model with training.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, enterprises must properly identify and protect various forms of human data (such as PII and HSHD) to comply with various regulations. That said, the volume of data received, transmitted, and stored, in conjunction with the complexity of various enterprises, makes such a process extremely difficult. For instance, an organization regularly receiving and managing petabytes of data per day cannot use human reviewers to manually check such data for PII, and yet must ensure that any PII in that data is protected. Moreover, rudimentary approaches to detecting PII in such data (such as using regular expressions to identify social security numbers in plain text) are slow, inaccurate, and often insufficient for identifying the broad spectrum of human data that might be included in a variety of forms of text.

To remedy these and other problems, aspects described herein use specific computing processes to identify human data. As will be described in further detail below, this process begins by receiving some tabular data and identifying a column name and a column description corresponding to a particular column. That column name might be checked against a variety of known human data categories and using a fuzzy string-matching algorithm to see if the column is obviously associated with human data. For example, if the column name is “Social Security Number,” then the process can easily end with the conclusion that the column contains PII. That said, in the circumstance where such the fuzzy matching algorithm does not easily identify the column as associated with human data, a more complex process is performed. An expanded column name is generated for the first column by providing, to a transformer model, the column name, and the transformer model may then map the column name to a vector space. That transformer model may be a character-level or sentence-level transformer model. An expanded column description may be generated in a similar fashion based on the column description. These mappings to vector space might be provided to a trained machine learning model, which might then output an indication of whether the corresponding column comprises human data (e.g., PII, HSHD). Metadata along those lines might be stored: for example, the column might be tagged as containing PII, instructions to tokenize the column might be generated and stored, or the like.

To provide an example of the above concept, assume that an enterprise receives a huge quantity of tabular data with hundreds of columns. In such a circumstance (which is quite common), manual processing of such tabular data to identify individual instances of PII would be computationally wasteful, inaccurate, and time-consuming. Instead, aspects described herein would, for a given column of the hundreds of columns, identify a column name (e.g., “custard”) and a column description (e.g., “location of customer”). Based on determining, using a fuzzy string-matching algorithm, that the column name does not correspond to one or more known human data categories (and instead seemingly describes food), the computing device would then generate an expanded column name by providing, to a transformer model, the name (“custard”) and receiving a mapping of that column name to a vector space. Note, advantageously, that the mapping of that column to the vector space helps remediate a possible typographical error: the proper name of the column might have been “custaddr”) (that is, “Customer Address”), but a typographical error might have resulted in an autocorrect to “custard,” and the mapping of the word to a character-by-character vector space might allow subsequent processing to analyze the word in the abstract without necessarily being concerned with its dictionary meaning. The mapping of the column name and/or a mapping of the column description might be provided to a machine learning model, which may output an indication that the column likely corresponds to a customer address, which is a form of PII. In turn, despite the typographical error, and without needing to analyze the actual data associated with the column (a process which may be computationally wasteful), the computing device is able to accurately identify that the column stores PII.

Aspects described herein improve the functioning of computers by improving the handling, processing, and maintenance of data. The sheer volume of data received, processed, and stored makes analysis of that data computationally expensive and time-consuming. With that said, as indicated above, data must necessarily be analyzed in certain circumstances where it may contain human data, such as PII or HSHD. The aspects described herein use a novel configuration of steps (such as fuzzy string-matching algorithms, transformer models, and machine learning models) to specifically address concerns with identifying human data in tabular data. The processes described herein could not be performed by humans in the human mind (in no small part due to the algorithms and machine learning models involved), but also because the underlying issue addressed by the present disclosure (identifying human data in large quantities of tabular data) is fundamentally rooted in computers. Indeed, as will be described in further detail below, certain steps in this process (e.g., such as using character-by-character transformer models) exhibit unique benefits (e.g., resiliency to typos) that allow computers to identify human data even in circumstances where a human would not easily be able to do so (and, in that case, in circumstances where the errors are likely human-created).

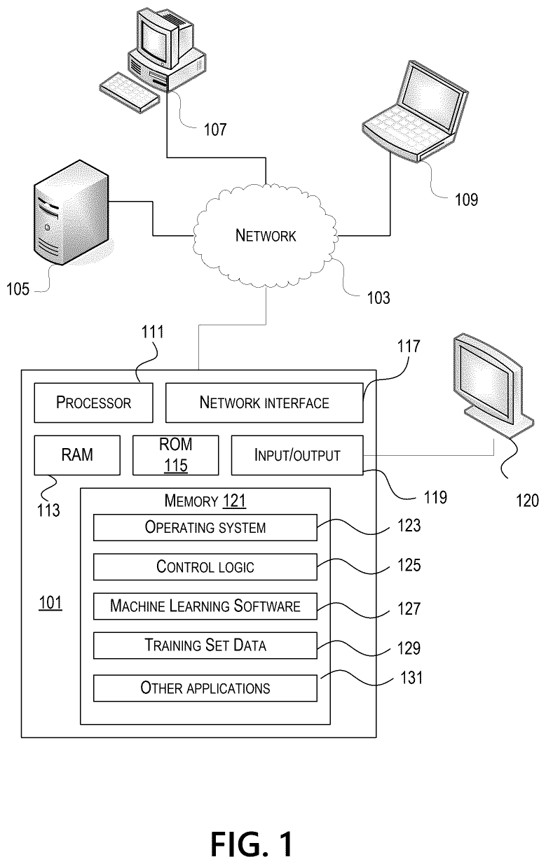

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topologies and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, training set data 129, and other applications 131. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QOS), etc. For example, computing devices 101, 105, 107, 109, and others may operate in concert to provide parallel computing features in support of the operation of control logic 125 and/or machine learning software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

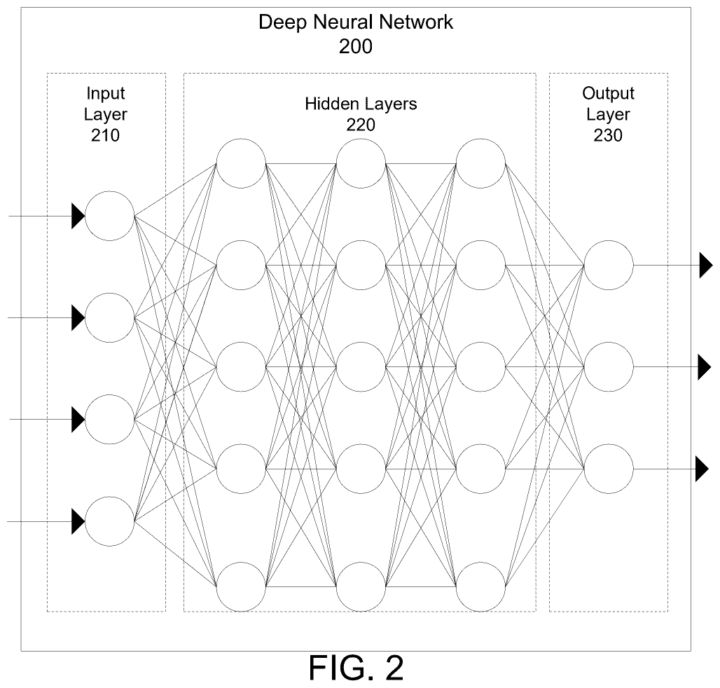

FIG. 2 illustrates an example of a deep neural network architecture 200. Such a deep neural network architecture may be all or portions of the machine learning software 127 shown in FIG. 1. That said, the architecture depicted in FIG. 2 need not be performed on a single computing device, and may be performed by, e.g., a plurality of computers (e.g., one or more of the devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220, and an output layer 230. A deep neural network, as used herein, may be an artificial network that has more than one hidden layer. Illustrated network architecture 200 is depicted with three hidden layers, and thus may be considered a deep neural network. The number of hidden layers employed in deep neural network architecture 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

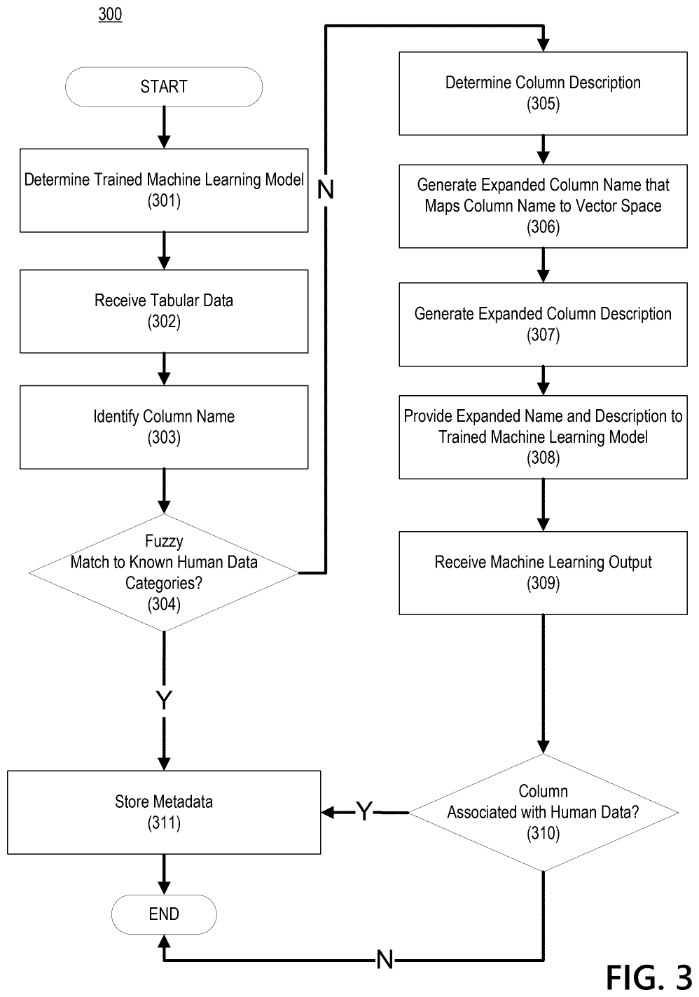

FIG. 3 depicts a method 300 comprising steps for identifying human data which may be performed by a computing device, such as any one of the devices described with respect to FIG. 1 and/or FIG. 2. The steps shown in FIG. 3 are illustrative, and may be re-arranged, omitted, and/or modified as desired. A computing device may comprise one or more processors and memory storing instructions that, when executed by the one or more processors, cause the performance of one or more of the steps depicted in FIG. 3. One or more non-transitory computer-readable media may store instructions that, when executed, cause the performance of one or more of the steps depicted in FIG. 3.

In step 301, the computing device may determine a trained machine learning model. This step may comprise receiving the trained machine learning model (e.g., from an external source) and/or generating the trained machine learning model. The trained machine learning model may be configured to predict whether a particular column name corresponds to human data, PII, HSHD, or the like. For example, the computing device may receive a trained machine learning model configured to predict, based on an input vector representing a column name, whether the column name corresponds to human data. The trained machine learning model may have been generated by training a machine learning model using training data comprising a plurality of vectors tagged based on whether each of the plurality of vectors correspond to human data. Training the machine learning model may comprise modifying, based on the training data, one or more weights of one or more nodes of an artificial neural network, such as the artificial neural network described with respect to FIG. 2.

Broadly, one approach to training the machine learning model to predict whether a particular column name corresponds to human data, PII, HSHD, or the like is to provide examples of column names and/or descriptions and whether those column names and/or descriptions correspond to human data (e.g., sensitive data, PII, HSHD, or the like). In some circumstances, this may comprise generating training data that comprises vector representations of column names and/or column descriptions that are tagged with indications of whether those vector representations correspond to human data.

In step 302, the computing device may receive tabular data. The tabular data may be received from a variety of sources, and may be any size. For example, the computing device may receive tabular data comprising a plurality of columns of data. As used herein, a column of data may refer to any subset of the tabular data, and need not necessarily refer to a visually-defined column. For example, the tabular data might be extensible Markup Language (XML) data, and the column might be an element of the XML data. As another example, the tabular data might be in a Comma-Separated Values (CSV) format, such that there are columns when depicted in certain representations (e.g., in a spreadsheets application), but not others (e.g., a text editor).

In step 303, the computing device may identify a column name. For example, the computing device may identify a first column name of a first column of the plurality of columns of the data. The column name may refer to any description of the subset of the tabular data, such as a textual string that describes the subset. Such a column name may, in various implementations and under various data standards, be identified by the tabular data itself, by metadata associated with the tabular data, or the like.

In step 304, the computing device may determine, using a fuzzy string-matching algorithm, whether the column name is associated with known human data categories. This process may thereby use a relatively straightforward algorithm (e.g., a fuzzy string-matching algorithm) to quickly determine whether a particular column is readily identifiable as one containing human data. In other words, this process may act as a rough filter for relatively easier cases whereby columns that obviously contain human data may be readily identified as such. For example, the computing device may process, using a fuzzy string-matching algorithm, the first column name to determine if the first column name corresponds to one or more known human data categories. Those one or more known human data categories may be strings known to be associated with human data, such as “social security number,” “home address,” “telephone number,” and the like. If the column name is associated with known human data categories, the method 300 proceeds to step 311. Otherwise, if the column name is not associated with known human data categories, the method 300 proceeds to step 305.

As part of the fuzzy string-matching algorithm process described above, the computing device may use a variety of fuzzy matching approaches, such as calculating the Levenshtein distances between a column name and the names of various known human data categories. For example, the computing device may calculate a Levenshtein distance between the first column name and a name of each of the one or more known human data categories. For instance, the Levenshtein distance between the known human data category “home address” and the column name “homeaddr” is 5 (suggesting quite a bit of similarity), whereas the Levenshtein distance between the known human data category “home address” and the column name “lasttransactiondate” is 18 (suggesting much less similarity). Such Levenshtein distances may be compared to a threshold (e.g., six) such that column names with low Levenshtein distances to known human data categories may be presumed to comprise human data.

As a brief introduction, step 305 through step 310 describe a process that is performed based on determining that the fuzzy string-matching algorithm did not find a match between the first column name and the one or more known human data categories. In other words, these steps are performed because an easy check (using a simplistic fuzzy string-matching algorithm) did not find a match and because a column might nonetheless still contain human data. This might occur in many circumstances, such as where column names are abstract, misspelled, and/or otherwise do not obviously reflect the storage of human data.

In step 305, the computing device may determine a column description. For example, the computing device may determine, based on the first column name, a column description corresponding to the first column. A column description may be any description of a subset of data that is additional to the column name. For instance, a column named “custaddr” might have a corresponding description “A customer's home address when registered for an account” or the like. In this manner, the description may provide additional information about content stored by a column. With that said, step 305 may be optional in many circumstances, and/or may be performed well before step 304. For instances, in cases where a column description is unavailable, step 305 may be omitted. That said, in some instances, the column description might also be matched (e.g., using a fuzzy string-matching algorithm) as part of step 304 as part of determining whether the column is readily and easy identifiable as one that contains human data. In that circumstance, step 305 might proceed step 304.

In step 306, the computing device may generate an expanded column name that maps the column name to vector space. An expanded column name may thereby comprise all or portions of an embedding of the column name. For example, the computing device may generate an expanded column name corresponding to the first column by providing, to a transformer model, the column name and then receiving, from the transformer model, a mapping of the column name to a vector space.

Prior to using a transformer model, the column name may be preprocessed. For example, abbreviations and similar shorthand may be automatically replaced, such that (for example) the column name “Cust Addr” is modified to “Customer Address.” Such automatic replacements may be valuable to preliminarily standardize input to the transformer model, which may aid in accuracy.

The expanded column name may be a character-by-character mapping of the column name to the vector space. For example, the transformer model may comprise a character-level transformer model such as Char-CNN, and the mapping of the column name to the vector space may comprise a character-by-character mapping of the column name to the vector space. This approach treats the column name at the character level, which can in certain circumstances allow for robust machine level processing of such embeddings even in circumstances where the column name comprises typographical errors. Indeed, broadly stated, the use of character-level mappings has various benefits: it avoids the need text preprocessing (e.g., tokenization, lemmatization, stemming), avoids issues with misunderstandings of semantics, it can easily handle noisy text, misspelled words, and the like, and it can avoid out-of-vocabulary issues. Also, in some instances, machine learning models trained on character-level mappings are often easy to train (and quick to train).

The expanded column name may be a word-by-word mapping of the column name to the vector space. For example, the transformer model may comprise a sentence-level transformer model (e.g., SimCSE), and the mapping of the column name to the vector space may comprise a word-by-word mapping of the column name to the vector space. Such a sentence-level transformer model may be supervised or unsupervised.

Testing reveals that both character-level and sentence-level mapping of the column name to the vector space provides significant accuracy improvements over the fuzzy matching approach (e.g., Levenshtein distance-based approach) described above. For example, based on testing of the present system, a fuzzy matching system achieved only an 81% weighted accuracy, whereas a Char-CNN based approach had an 89% accuracy and was 100 times faster. With that said, comparisons of character-level and sentence-level mapping indicate various differences. Indeed, testing of Char-CNN based approaches and SimCSE-based approaches indicated that in some circumstances sentence-level mapping performed slightly better; however, such mapping had various limitations depending on the specific nature of the column names.

Given that both character-level and sentence-level mapping have advantages and disadvantages based on (for instance) the nature of the column names, both approaches may be used in parallel. For example, two different mappings may be generated (one sentence-level and one character-level) and provided to the same or different trained machine learning models. The output of such trained machine learning models might be weighted (e.g., averaged). In this manner, the advantages and disadvantages of both might be balanced.

The transformer model may be pretrained and/or otherwise fine-tuned to improve accuracy. For example, the computing device may pretrain the transformer model based on a training set comprising a plurality of different sentence pairs. To provide a particular example, during testing, significant accuracy improvements to a transformer model were found by pre-training the model using over one million sentence pairs from multi-genre natural language inference datasets. With that said, various other forms of training and fine tuning may be performed based on the particularities of the model.

In step 307, the computing device may generate an expanded column description. The process for generating an expanded column description may be the same or similar as the process described above for generating an expanded column name. For example, the computing device may generate an expanded column description corresponding to the first column by processing the column description.

In step 308, the computing device may provide, to the trained machine learning model, the expanded column name and/or the expanded column description to the trained machine learning model. For example, the computing device may provide the expanded column name and an expanded column description to one or more input nodes of the trained machine learning model. As indicated previously, in some circumstances, the expanded column name may be provided to a first trained machine learning model, and the expanded column description may be provided to a second trained machine learning model, such that the trained machine learning models may predict whether human data is present based on different training data (e.g., training data based on column names and training data based on column descriptions), and such that subsequent output of the different machine learning models may be weighted (e.g., averaged).

In step 309, the computing device may receive machine learning output from the trained machine learning model. The output may indicate a likelihood that a portion of tabular data corresponding to a column name and/or column description contains human data, such as PII, HSHD, or the like. For example, the computing device may receive, as output from one or more output nodes of the trained machine learning model, an indication of whether the first column comprises human data. The output may comprise a numerical value (e.g., a percentage likelihood that the column contains PII), a Boolean value (e.g., a true/false indication of whether the column is predicted to contain human data), or the like.

In step 310, the computing device may determine, based on the machine learning output, whether the column is associated with human data. This may comprise processing the output of the trained machine learning model, such as by comparing it to a predetermined threshold. For instance, if the output indicates a 75% likelihood that data in a column comprises PII, and if the threshold is 60%, then the computing device may determine that the column stores data comprising PII. If the column is associated with human data, the method 300 proceeds to step 311. If the column is not associated with human data, the method 300 ends.

In step 311, the computing device may store metadata based on determining that the column is associated with human data. For example, the computing device may store metadata, associated with the first column, that indicates whether the first column comprises human data.

As part of step 311, the computing device may automatically modify all or portions of the tabular data. For example, based on determining that the column is associated with human data, the computing device may execute an algorithm configured to tokenize and/or edit all or portions of the data associated with the column. This might include, for example, programmatically replacing first data (e.g., sixteen-digit numbers which might be credit card numbers) with second data (e.g., all zeroes).

After step 311, the computing device may further train the trained machine learning model based on subsequent activity. This may include further training based on direct processing of data associated with the column. For example, the computing device may process at least a portion of the tabular data corresponding to the first column to identify one or more human data elements, determine, based on the one or more human data elements, that the first column stores human data, and further train the trained machine learning model based on the determination that the first column stores human data. In other words, once the computing device has identified that a column comprises human data based on the column name/description, it might check its own work by actually processing the data of that column and then, based on whether the processed data actually contained human data, further train the machine learning model (e.g., to indicate it was correct or incorrect). This further training process may additionally and/or alternatively include further training the trained machine learning model based on user feedback. For example, the computing device may receive, via a user interface, user input indicating that the first column stores human data and then further train the trained machine learning model based on the user input indicating that the first column stores human data. In this manner, an administrator might, upon checking the work of the process, further train the machine learning model (e.g., to indicate it was correct or incorrect).

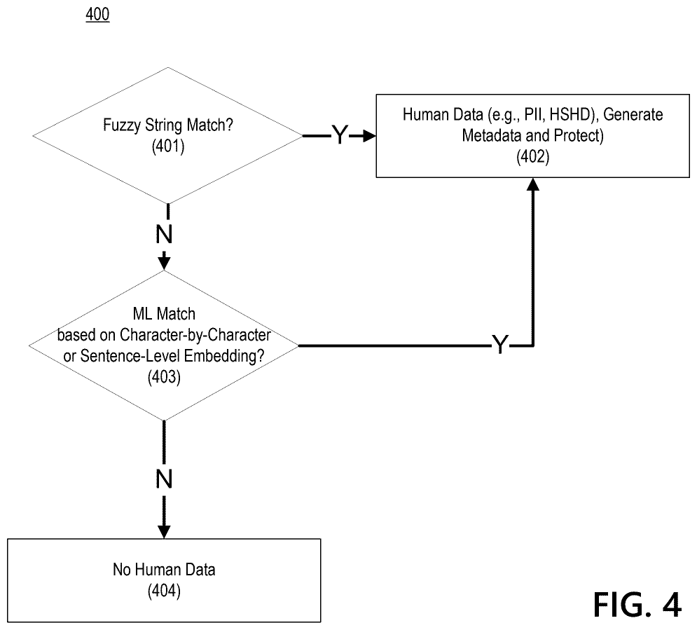

FIG. 4 depicts a simplified flow 400 for depicting how the process illustrated in FIG. 3 processes data. As shown in decision 401, the process first begins by applying a rough filter, a fuzzy string-matching algorithm, to a column name to determine whether it corresponds to one or more known human data categories (e.g., “Social Security Number,” “Home Address”). If there is a match, then the process can easily conclude (as represented in box 402) that the column contains human data such as PII or HSHD, and can take steps to protect that data. That said, if there is no such match using the fuzzy string-matching algorithm, in decision 403, it is decided whether the machine learning model(s) indicate, based on input (e.g., the embeddings such as the character-by-character mapping of the column name and/or description and/or the sentence-level mapping of the column name and/or description), the possibility of human data. If the machine learning output suggests such human data, then the process can conclude (as represented in box 402) that the column contains human data such as PII or HSHD, and can take steps to protect that data. That said, if no such output is provided from the trained machine learning model, box 404 indicates that the process ends with a conclusion that no human data is present.

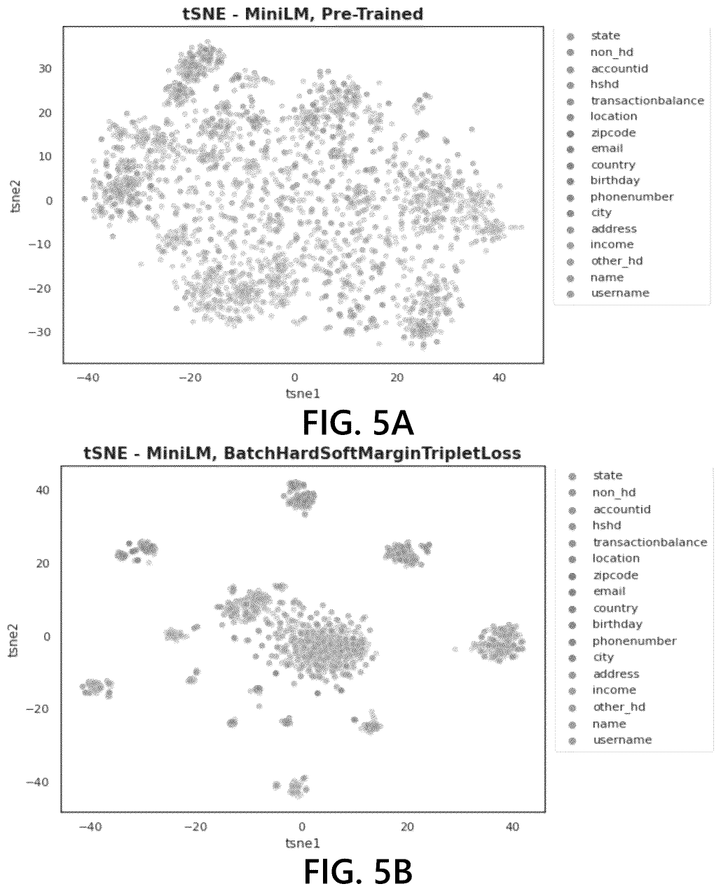

FIG. 5A depicts illustrative performance based on a MiniLM model without training, and FIG. 5B depicts illustrative performance based on a MiniLM model with training. In particular, these two figures show how training and improvement of embedding models and appropriate training of a machine learning model can radically improve the ability of the system to categorize columns into categories such as “country,” “birthday,” and the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing device configured to detect human data in a data set based on column names of that data, the computing device comprising:
one or more processors; and
memory storing instructions that, when executed by the one or more processors, cause the computing device to:
receive a trained machine learning model configured to predict, based on an input vector representing a column name, whether the column name corresponds to human data, wherein the trained machine learning model was generated by training a machine learning model using training data comprising a plurality of vectors tagged based on whether each of the plurality of vectors correspond to human data;
receive tabular data comprising a plurality of columns of data;
identify a first column name of a first column of the plurality of columns of the data;
process, using a fuzzy string-matching algorithm, the first column name to determine if the first column name corresponds to one or more known human data categories;
based on determining that the fuzzy string-matching algorithm did not find a match between the first column name and the one or more known human data categories:
determine, based on the first column name, a column description corresponding to the first column;
generate an expanded column name corresponding to the first column by:
providing, to a transformer model, the column name, and
receiving, from the transformer model, a mapping of the column name to a vector space;
generate an expanded column description corresponding to the first column by processing the column description;
provide the expanded column name and an expanded column description to one or more input nodes of the trained machine learning model;
receive, as output from one or more output nodes of the trained machine learning model, an indication of whether the first column comprises human data; and
store metadata, associated with the first column, that indicates whether the first column comprises human data.

2. The computing device of claim 1, wherein the transformer model is a character-level transformer model, and wherein the mapping of the column name to the vector space comprises a character-by-character mapping of the column name to the vector space.

3. The computing device of claim 1, wherein the transformer model is a sentence-level transformer model, and wherein the mapping of the column name to the vector space comprises a word-by-word mapping of the column name to the vector space.

4. The computing device of claim 1, wherein the instructions, when executed by the one or more processors, further cause the computing device to:
pretrain the transformer model based on a training set comprising a plurality of different sentence pairs.

5. The computing device of claim 1, wherein the instructions, when executed by the one or more processors, further cause the computing device to process the first column name to determine if the first column name corresponds to the one or more known human data categories by causing the computing device to:
calculate a Levenshtein distance between the first column name and a name of each of the one or more known human data categories.

6. The computing device of claim 1, wherein the instructions, when executed by the one or more processors, further cause the computing device to:
process at least a portion of the tabular data corresponding to the first column to identify one or more human data elements;
determine, based on the one or more human data elements, that the first column stores human data; and
further train the trained machine learning model based on the determination that the first column stores human data.

7. The computing device of claim 1, wherein the indication of whether the first column comprises human data comprises an indication of whether the first column comprises Personally Identifiable Information.

8. The computing device of claim 1, wherein the instructions, when executed by the one or more processors, further cause the computing device to:
receive, via a user interface, user input indicating that the first column stores human data; and
further train the trained machine learning model based on the user input indicating that the first column stores human data.

9. A method for detecting human data in a data set based on column names of that data, the method comprising:
receiving a trained machine learning model configured to predict, based on an input vector representing a column name, whether the column name corresponds to human data, wherein the trained machine learning model was generated by training a machine learning model using training data comprising a plurality of vectors tagged based on whether each of the plurality of vectors correspond to human data;
receiving tabular data comprising a plurality of columns of data;
identifying a first column name of a first column of the plurality of columns of the data;
processing, using a fuzzy string-matching algorithm, the first column name to determine if the first column name corresponds to one or more known human data categories;
based on determining that the fuzzy string-matching algorithm did not find a match between the first column name and the one or more known human data categories:
determining, based on the first column name, a column description corresponding to the first column;
generating an expanded column name corresponding to the first column by:
providing, to a transformer model, the column name, and
receiving, from the transformer model, a mapping of the column name to a vector space;
generating an expanded column description corresponding to the first column by processing the column description;
providing the expanded column name and an expanded column description to one or more input nodes of the trained machine learning model;
receiving, as output from one or more output nodes of the trained machine learning model, an indication of whether the first column comprises human data; and
storing metadata, associated with the first column, that indicates whether the first column comprises human data.

10. The method of claim 9, wherein the transformer model is a character-level transformer model, and wherein the mapping of the column name to the vector space comprises a character-by-character mapping of the column name to the vector space.

11. The method of claim 9, wherein the transformer model is a sentence-level transformer model, and wherein the mapping of the column name to the vector space comprises a word-by-word mapping of the column name to the vector space.

12. The method of claim 9, further comprising:
pretraining the transformer model based on a training set comprising a plurality of different sentence pairs.

13. The method of claim 9, wherein processing the first column name to determine if the first column name corresponds to the one or more known human data categories comprises:
calculating a Levenshtein distance between the first column name and a name of each of the one or more known human data categories.

14. The method of claim 9, further comprising:
processing at least a portion of the tabular data corresponding to the first column to identify one or more human data elements;
determining, based on the one or more human data elements, that the first column stores human data; and
further training the trained machine learning model based on the determination that the first column stores human data.

15. The method of claim 9, wherein the indication of whether the first column comprises human data comprises an indication of whether the first column comprises Personally Identifiable Information.

16. The method of claim 9, further comprising:
receiving, via a user interface, user input indicating that the first column stores human data; and
further training the trained machine learning model based on the user input indicating that the first column stores human data.

17. One or more non-transitory computer-readable media storing instructions that, when executed by one or more processors of a computing device, cause the computing device to detect human data in a data set based on column names of that data by causing the computing device to:
receive a trained machine learning model configured to predict, based on an input vector representing a column name, whether the column name corresponds to human data, wherein the trained machine learning model was generated by training a machine learning model using training data comprising a plurality of vectors tagged based on whether each of the plurality of vectors correspond to human data;
receive tabular data comprising a plurality of columns of data;
identify a first column name of a first column of the plurality of columns of the data;
process, using a fuzzy string-matching algorithm, the first column name to determine if the first column name corresponds to one or more known human data categories;
based on determining that the fuzzy string-matching algorithm did not find a match between the first column name and the one or more known human data categories:
determine, based on the first column name, a column description corresponding to the first column;
generate an expanded column name corresponding to the first column by:
providing, to a transformer model, the column name, and
receiving, from the transformer model, a mapping of the column name to a vector space;
generate an expanded column description corresponding to the first column by processing the column description;
provide the expanded column name and an expanded column description to one or more input nodes of the trained machine learning model;
receive, as output from one or more output nodes of the trained machine learning model, an indication of whether the first column comprises human data; and
store metadata, associated with the first column, that indicates whether the first column comprises human data.

18. The one or more non-transitory computer-readable media of claim 17, wherein the transformer model is a character-level transformer model, and wherein the mapping of the column name to the vector space comprises a character-by-character mapping of the column name to the vector space.

19. The one or more non-transitory computer-readable media of claim 17, wherein the transformer model is a sentence-level transformer model, and wherein the mapping of the column name to the vector space comprises a word-by-word mapping of the column name to the vector space.

20. The one or more non-transitory computer-readable media of claim 17, wherein the instructions, when executed by the one or more processors, further cause the computing device to:
pretrain the transformer model based on a training set comprising a plurality of different sentence pairs.
